(19) United States
(12) Patent Application Publication
(10) Pub. No.: US 2024/0249159 A1
(43) Pub. Date: Jul. 25, 2024

(54) BEHAVIORAL FORENSICS IN SOCIAL NETWORKS

(71) Applicant: Regents of the University of Minnesota, Minneapolis, MN (US)

(72) Inventors: Euna Mehnaz Khan, Minneapolis, MN (US); Ayush Ram, Minneapolis, MN (US); Bhavtosh Rath, Minneapolis, MN (US); Jaideep Srivastava, Minneapolis, MN (US); Emily Vraga, Minneapolis, MN (US)

(21) Appl. No.: 18/540,131

(22) Filed: Dec. 14, 2023

Related U.S. Application Data
(60) Provisional application No. 63/480,801, filed on Jan. 20, 2023.

(51) Int. Cl. G06N 5/022; G06F 16/28

(52) U.S. Cl. CPC G06N 5/022; G06F 16/287; G06Q 50/01

(57) ABSTRACT

A method includes retrieving social network connections of a user from a database and using the social network connections to assign a label to the user. The label indicates how the user will react to messages containing misinformation and messages containing refutations of misinformation. The label is assigned to the user without determining how the user has reacted to past messages containing misinformation.

### CROSS-REFERENCE TO RELATED APPLICATION

The present application is based on and claims the benefit of U.S. provisional patent application Ser. No. 63/480,801, filed Jan. 20, 2023, the content of which is hereby incorporated by reference in its entirety.

### BACKGROUND

Online Social Networks allow users to create “pages” where they may post and receive messages. One user may “follow” another user so that any message posted by the followed user (the followee) is sent to the follower. The follower-followee relationships between users form networks of users with each user representing a node on the network and each follower-followee relationship of a user representing an edge of the network.

The discussion above is merely provided for general background information and is not intended to be used as an aid in determining the scope of the claimed subject matter. The claimed subject matter is not limited to implementations that solve any or all disadvantages noted in the background.

### SUMMARY

A method includes setting a respective label for a plurality of users, wherein the plurality of users is limited to users who have received both a message containing false information and a message containing a refutation of the false information. A classifier is constructed using the labels of the users and the classifier is used to determine a label for an additional user.

In accordance with a further embodiment, a method includes retrieving social network connections of a user from a database and using the social network connections to assign a label to the user. The label indicates how the user will react to messages containing misinformation and messages containing refutations of misinformation. The label is assigned to the user without determining how the user has reacted to past messages containing misinformation.

In accordance with a still further embodiment, a system includes a two-class classifier that places a user in one of two classes based upon social network connections of the user and a multi-class classifier that places the user in one of a plurality of classes based upon the social network connections of the user. The multi-class classifier is not used when the user is placed in a first class of the two classes by the two-class classifier and is used when the user is placed in a second class of the two classes by the two-class classifier.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system for training and utilizing a system that labels users.

FIG. 2 is a state diagram for a method of labeling users.

FIG. 3(a) is a t-SNE plot of the learned LINE embeddings depicting two classes (disengaged and others) with four feature dimensions.

FIG. 3(b) is a t-SNE plot of the learned LINE embeddings depicting two classes (disengaged and others) with eight feature dimensions.

FIG. 3(c) is a t-SNE plot of the learned LINE embeddings depicting two classes (disengaged and others) with sixteen feature dimensions.

FIG. 3(d) is a t-SNE plot of the learned LINE embeddings depicting two classes (disengaged and others) with thirty-two feature dimensions.

FIG. 3(e) is a t-SNE plot of the learned LINE embeddings depicting two classes (disengaged and others) with sixty-four feature dimensions.

FIG. 3(f) is a t-SNE plot of the learned LINE embeddings depicting two classes (disengaged and others) with one hundred twenty-eight feature dimensions.

FIG. 4(a) is a t-SNE plot of the learned LINE embeddings depicting four engaged classes with four feature dimensions.

FIG. 4(b) is a t-SNE plot of the learned LINE embeddings depicting four engaged classes with eight feature dimensions.

FIG. 4(c) is a t-SNE plot of the learned LINE embeddings depicting four engaged classes with sixteen feature dimensions.

FIG. 4(d) is a t-SNE plot of the learned LINE embeddings depicting four engaged classes with thirty-two feature dimensions.

FIG. 4(e) is a t-SNE plot of the learned LINE embeddings depicting four engaged classes with sixty-four feature dimensions.

FIG. 4(f) is a t-SNE plot of the learned LINE embeddings depicting four engaged classes with one hundred twenty-eight feature dimensions.

FIG. 5(a) is a horizontal bar plot showing the precision of four different engaged classes using different machine learning models for the multi-class classification step.

FIG. 5(b) is a horizontal bar plot showing the recall of four different engaged classes using different machine learning models for the multi-class classification step.

FIG. 5(c) is a horizontal bar plot showing the F1 score of four different engaged classes using different machine learning models for the multi-class classification step.

FIG. 6 is a flow diagram of a method of setting primary labels for training data in accordance with one embodiment.

FIG. 7 is a block diagram of the elements used in the method of FIG. 6.

FIG. 8 is a flow diagram of a method of forming feature vectors for training classifiers in accordance with one embodiment.

FIG. 9 is a block diagram of the elements used in the method of FIG. 8.

FIG. 10 is a flow diagram of a method of forming classifiers in accordance with one embodiment.

FIG. 11 is a block diagram of elements used in the method of FIG. 10.

FIG. 12 is a flow diagram of a method of labeling users relative to false messages and refutation messages without examining the users' message histories in accordance with one embodiment.

FIG. 13 is a block diagram of elements used in the method of FIG. 12.

FIG. 14 is a block diagram of a server.

### DETAILED DESCRIPTION

In recent times, the ease of access to Online Social Networks and the extensive reliance on such networks for news has increased the dissemination of misinformation. The spread of misinformation has severe impacts on our lives as witnessed during the COVID-19 pandemic. Hence, it is important to detect misinformation along with its spreaders. It is worth noting that misinformation and disinformation are very related yet different terms: misinformation is incorrect or misleading information whereas disinformation is spread deliberately with the intention to deceive.

Fact-checking websites often debunk misinformation and publish its refutation. As a result, both the misinformation and its refutation can co-exist in the network and people can be exposed to them in different orders. So, at some point in time, they might get exposed to the misinformation, and retweet it. Later, they may get exposed to its refutation and retweet it. Since they have corrected their mistake, it can be inferred that they had spread the misinformation unintentionally. Social media usually bans or flags accounts that they deem to be objectionable without investigating the intention of those people sharing the misinformation. This results in many unfair bans of accounts that were simply deceived by the misinformation. On the other hand, some people may not correct their mistakes, or despite receiving the refutation they may choose to retweet the misinformation. These kinds of activities reveal their bad intention and hence these people can be considered as malicious. Again, some people might be smart enough to identify misinformation and choose to share refutations instead, which indicates good intentions. Identifying these different groups of people will enable efficient suppression and correction of misinformation. For instance, a social network may flag or ban malicious people who purposefully spread misinformation and may incentivize good people to spread refutations of misinformation. The followers of malicious people can also be sent the refutation as a preventive measure. Inoculating people against common misinformation and misleading tactics has shown promise, so targeting vulnerable groups more precisely offers great advantages.

In some embodiments, people are labeled into one of five defined classes only after they have been exposed to both misinformation and its refutation. This permits the labeling to take into consideration the user's possible intentions. Next, from the follower-followee network of these labeled people, the network features of each user are extracted using graph embedding models. The network features are used along with profile features of the user to train a machine learning classification model that predicts the labels. In this way, for users without past behavioral histories, it is possible to predict the labels from the user's network and profile features. We have tested our model on a Twitter dataset, and have achieved 77.45% precision and 75.80% recall in detecting the malicious class (the extreme bad) where the accuracy of the model is 73.64% with a weighted F1 score of 72.22%, thus significantly outperforming the baseline models. Among the contributions of these embodiments are the following:
People are labeled only after being exposed to both false information and its refutation.
People are assigned one of five categories producing a granular level classification of misinformation, disinformation, and refutation spreaders which aims to identify the intent of people based on their history of actions.
The network features of users is leveraged to predict their classes so that people without any behavioral property can also be categorized.

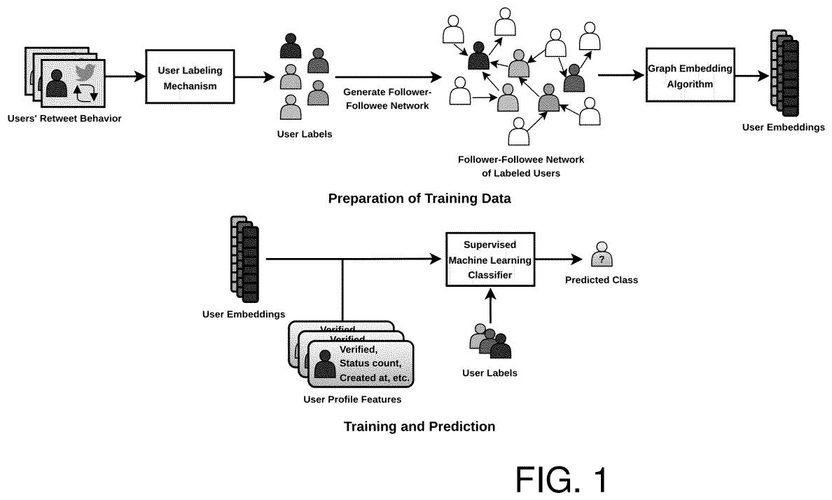

An overview of the proposed approach, which we name behavioral forensics, is demonstrated in FIG. 1.

The present embodiments considered the fact that a person can exhibit a series of behaviors when exposed to misinformation and its refutation. People's perceptions of truth change as they get more exposed to the facts. They may retract their previous actions (retweeting the misinformation) by doing something opposite (retweeting the refutation) to account for their mistake, which implies good behavior. On the other hand, labeling them as malicious or bad people based on the fact that they chose not to share a refutation and instead shared the misinformation gives more evidence than just relying on the fact that they shared the misinformation. The present embodiments identify the multiple states that one can go through when exposed to both misinformation and its refutation, and classify them using their network properties.

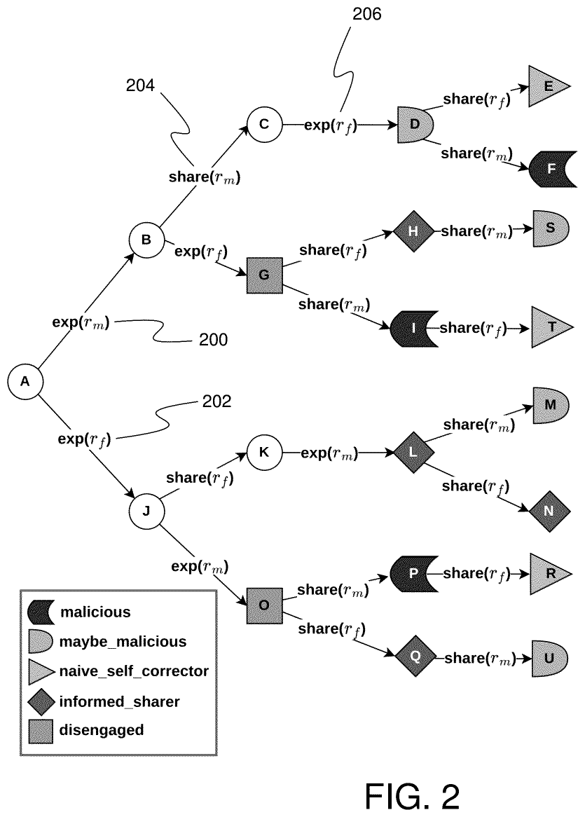

While labeling people, the embodiments consider only those people who are exposed to at least one pair of misinformation and its refutation and label them into one of the five following categories based on the sequence of actions they take upon the exposures. The possible series of behavioral actions is depicted using a state diagram in FIG. 2. Here, misinformation and its refutation are denoted by rₘ and r_{f}, respectively. Sharing or retweeting rₘ is represented by share (rₘ) whereas exposure to rₘ is represented by exp(rₘ). The same applies for r_{f}. Self-loops are not shown in the diagram. For instance, if a person is at state G and they share an rₘ, they go to state I. Now, they stay at state I if they repeatedly keep sharing the rₘ. The self-loops are removed from the diagram for clarity of the figure.

1. malicious: These are the people who spread misinformation knowingly: after being exposed to both rₘ and r_{f}, they decide to spread rₘ, not re. Since refutations are published by fact-checking websites, they are clear to identify as true and usually are not confused with rₘ. So, when a person shares the rₘ even after getting the r_{f}, they can be considered to have malicious intent, hence categorized as malicious.

In FIG. 2, a person in state G or O is exposed to both rₘ and r_{f} (A→B→G, A→J→O). Now, if they choose to share the rₘ, they go to state I (G→I) and P (O→P), respectively. If they do not take further action, or repeatedly keep sharing the rₘ, we label them as malicious. In another scenario, a person shares rₘ after getting it (A→B→C) and then they get the r_{f} (C→D). Now, if they still choose to share the rₘ again (D→F), we label them as malicious. The malicious class of people is an extremely bad category in terms of misinformation spread and should be banned or flagged.

2. maybe_malicious: This class refers to the following group of people:
people who have shared the misinformation (A→B→C), then have received its refutation (C→D) but did not share the refutation (they stay at state D). These people did not correct their mistake which may indicate malicious intent or it is possible that they got the r_{f} so late that the topic has become outdated.
people who shared the rₘ after sharing its r_{f} (perhaps they cannot distinguish between true and false information although r's are usually clear to identify as true). The sequences A→B→G→H→S, A→J→K→L→M, A→J→O→Q→U demonstrate this kind of behavior.

The intent of these people is not clear from their behavior. But since they shared rₘ as the latest action, we grouped them as a separate category called maybe_malicious. These people are not as bad as the malicious class of people, however, they still contribute to misinformation spread. Less intense measures like providing refutations to their followers can be taken to account for the harm caused by them.

3. naïve_self_corrector: These people got deceived by the rₘ and shared it (naive behavior) but later corrected their mistake by sharing the r_{f} (self-correcting behavior). The sequences A→B→C→D→E, A→B→G→I→T, A→J→O→P→R fall into this category. These people can be provided r_{f} early to prevent them from naively believing and spreading rₘ and be utilized to spread the true information.
4. informed_sharer: This category includes two types of people:
People who shared only r_{f} after exposure to both rₘ and r_{f} (A→B→G→H, A→J→O→Q).
People who shared r_{f} (A→J→K), then after receiving rₘ (K→L), did not share it (stay at state L) or they shared the refutation again (L→N). Both the states L and N fall under this category.

This group of people are smart enough to distinguish between true and false information and are willing to fight misinformation spread by sharing the refutation. So, they should be provided with refutations on the onset of misinformation dissemination to contain its spread.

5. disengaged: People who received both rₘ and r_{f} but shared nothing are defined as disengaged people. This group of people does not incline to share any true or false information. People in state G (sequence A→B→G) and state O (sequence A→J→O) are disengaged people.

It should be noted that when a person is in state G and takes no further action, they are identified as disengaged. But if they share something at this point, then they make a transition to state H or I depending on what they share. For instance, if they share r_{f}, they go to state H. Now, if they stop here, then they are defined as informed_sharer. However, if they share I'm here, they go to state S which indicates maybe-malicious class.

Note that, if different definitions are created for the classes following different labeling mechanisms, our model can still be used in terms of the steps shown in FIG. 1: the embedding features can be generated using the follower-followee network of the labeled people and those can be used to train machine learning models.

In accordance with one embodiment, multiple pairs of misinformation (rₘ) and corresponding refutations (r_{f}) are used to label a set of users to train the machine learning models. Ideally, we wanted to label someone as one class, i.e., malicious if they had shown that behavior multiple times across our many pairs of rₘ and r_{f}. Although this would have been a more robust labeling of people, we observed from our dataset that a very small number of people showed behavior that falls into a class other than disengaged, and the number of people exhibiting that behavior multiple times was even less. To account for this problem, we labeled people according to our state diagram in FIG. 2 whenever they showed some behavior for at least one pair of rₘ-r_{f}. For users who showed a behavior for only one pair of rₘ and r_{f}, received a single final label. On the other hand, people who had shown multiple behaviors across different pairs of rₘ and r_{f}, got multiple labels. If a person receives multiple same labels, then we label them as the corresponding class. However, if they receive other label(s) with disengaged label(s), then we remove the disengaged label(s) and use the rest of the non-disengaged label(s) to convert them into a single label. We do this because showing disengaged behavior is trivial since it means taking no action whereas the other behaviors require some sort of action which is essential to identify. Next, we use a Likert scale-like representation to convert multiple labels for a user into a single label, as described below:

First, we represent the four different non-disengaged classes (malicious, maybe_malicious, naïve_self_corrector, informed_sharer) using the integers 1, 2, 3, and 4, respectively. Suppose we have m labels for a person represented by the list l=[l₁, l₂, . . . , lₘ]. After converting the labels to the integers, we get a list of integers [n₁, n₂, . . . , nₘ]. Since we are studying behavior, and the distribution of labels for the same user was skewed, we take the median of these numbers. If there is a tie between the medians, we take the higher integer to avoid false positives (assuming positive as the malicious). However, if we had used mean (with rounding up to get an integer) instead of median, it would have changed the final label for only 8 users out of 218 multi-label users in one training data set.

For example, if l=[malicious, naïve_self_corrector, informed_sharer], then we get 3 as the median of [1+3+4], which refers to the class naïve_self_corrector.

Graph embedding algorithms are used to generate a low dimensional vector representation for each of the nodes in the network, preserving the network's topology and homophily of the nodes. Nodes with similar neighborhood structure should have similar vector representations. As we aim to utilize network properties of the people to distinguish between different classes, we apply the existing graph embedding methods. In particular, as the next step of our model, we build a network using the followers and followees of the labeled users. Then, we use a graph embedding model to extract the network features of these users. Specifically, one embodiment uses a second order version of LINE (as the network is directed) and another embodiment uses PyTorch-BigGraph (PBG) for this purpose. The LINE algorithm captures the local and global network structure by considering the fact that similarity between two nodes is also dependent on the number of neighbors they share besides the existence of direct link between them. This is important in our problem because people from the same class may not be connected to each other, but they might be connected to the same group of people, which the LINE algorithm still identifies as a similarity. For instance, people from the malicious class may or may not be connected to each other but their target people (whom they want to relay the misinformation to) might be the same. Again, nodes from the same class may form a cluster or community with lots of interconnections and common neighbors. The LINE graph embedding technique is able to capture these aspects. On the other hand, the PBG embedding system uses a graph partitioning scheme that allows it to train embeddings quickly and scale to networks with millions of nodes and trillions of edges.

Profile features of the users are then combined with their learned graph embeddings and the combination is used to train different machine learning models. These models are then used to make predictions. Due to the heavy imbalance between the disengaged class and other classes, the classification is performed in two steps. First, we classify people into the disengaged category and others category with under sampling of the disengaged class. Next, we classify the others category into the four defined classes. The overview of the proposed model is depicted in FIG. 1.

Experiments were performed for the embodiments. The “False and refutation information network and historical behavioral data” dataset was used for the experiments and model evaluations. This dataset contains misinformation and refutation related data for 10 news events (all on political topics), occurring on Twitter during 2019, identified through altnews.in, a popular fact-checking website. For each news event, the dataset includes the single original tweet (source tweet) information for a piece of misinformation and the list of people who retweeted that misinformation along with the timestamp of the retweets. It also contains the same information for its refutation tweet. As the time of retweet is missing for news events 1 and 9, we have used data for news events 2 through 8 and 10 (a total of 8 news events).

The dataset also includes the follower-followee network information for the retweeters of the misinformation and its refutation. Since people belonging to the disengaged category have retweeted neither of the true and false information, we had to collect their follower-followee network using Twitter API.

The following Twitter profile features of users in the follower-followee network is also included in the dataset: Follower Count, Friend (Followee) Count, Statuses Count (number of tweets or retweets issued by the user), Listed Count (number of public lists the user is a member of), Verified User (True/False), Protected Account (True/False), Account Creation Time.

As part of the experiment, people who are exposed to at least one of the eight news events' both misinformation (rₘ) and refutation tweets (r_{f}) were labeled using the state diagram in FIG. 2. Now, a person is exposed to rₘ or r_{f} when a person they follow has shared it and they see it. Twitter's data collection API does not let us collect the list of people who actually saw the tweet and the time when they saw it. So, we assume that when a person shares rₘ (or re), all of their followers are exposed to it. Similarly, we have used the following policy to set the exposure time1:
We assume that when a person tweets or retweets a piece of information (rₘ or r_{f}), all of their followers get exposed to it, and so, we set their exposure time equal to the (re)tweet time.
If more than one followee of a person retweets the same message, then we set the exposure time of that person (to that message) to the earliest retweet time.
If the user retweets the original tweet before any of the above events happens, we set the exposure time equal to the time of the user's first retweet of that message.

Comparing the sequences of exposure time and retweet time, we have been able to label people into one of the five defined categories. After labeling, we have got 1,365,929 labeled users where 99.75% (1,362,510) of them fall into the disengaged category and 0.25% (3,419) of them are categorized as the other 4 classes. The number of users in these classes are: malicious: 926, maybe_malicious: 222, naïve_self_corrector: 1,452, informed_sharer: 819. We can see that most of the people (around 42%) are categorized as naïve_self_corrector, which indicates that most of the people who transmit misinformation, do that mistakenly. Again, the number of people in the malicious and informed_sharer categories implies that the number of people in the extreme good class is almost equal, if not more, to the number of people in the extreme bad class.

After the users were assigned labels, follower-followee information of these labeled people was extracted from the dataset and was used to construct a network. We randomly under-sampled the people belonging to the disengaged category and kept 4,059 of them for the analysis. After constructing the network, we had 7.5M (7,548,934) nodes and 25M (25,037,335) edges. Then, we used graph embedding models LINE and PBG (as mentioned in Section 4.2) to extract their network features. We generated embeddings of different dimensions (4d, 8d, 16d, 32d, 64d, and 128d) so that we could test the performance of each number of dimensions.

Next, we normalized the embedding features. We used the embedding features directly on various two-class classifiers for the two-class classification step (disengaged and others). Since the embedding features have been able to get over 99% accuracy as discussed below, we have not included the profile features at this step. However, for the multi-class classification step, we concatenated the normalized profile features with the learned embeddings. The Boolean (True/False) features (verified user, protected account) have been converted to integers (1/0) with the account creation time being converted to normalized account age (in days).

For both the classification steps, we used k-Nearest Neighbors algorithm (k-NN), Logistic Regression, Naive Bayes, Decision Tree, Random Forest (with 100 trees), Support Vector Machine (SVM), and Bagged classifier (with base estimator SVM). For k-NN, k=5 has seemed to produce better results. One-vs-rest scheme was used for Logistic Regression in the multi-class classification step. For the two-class classification step, the class distribution was almost balanced (4,059 disengaged and 3,419 others) after the under sampling of the disengaged users. However, for the multi-class classification step, the class distribution is found to be imbalanced. To account for this problem, we have set the class_weights parameter of the classifiers to ‘balanced’ when available which automatically adjusts weights inversely proportional to class frequencies in the input data. For classifiers that do not have this parameter, we have used Synthetic Minority Oversampling Technique (SMOTE) to balance the class distribution.

For both the classification steps, two baseline models are considered:

(1) Baseline 1, which predicts all samples as the majority class (disengaged for step 1 and naïve_self_corrector for step 2), and (2) Baseline 2, which predicts random class. K-fold cross-validation with K=10 has been used for evaluation purposes (in both steps).

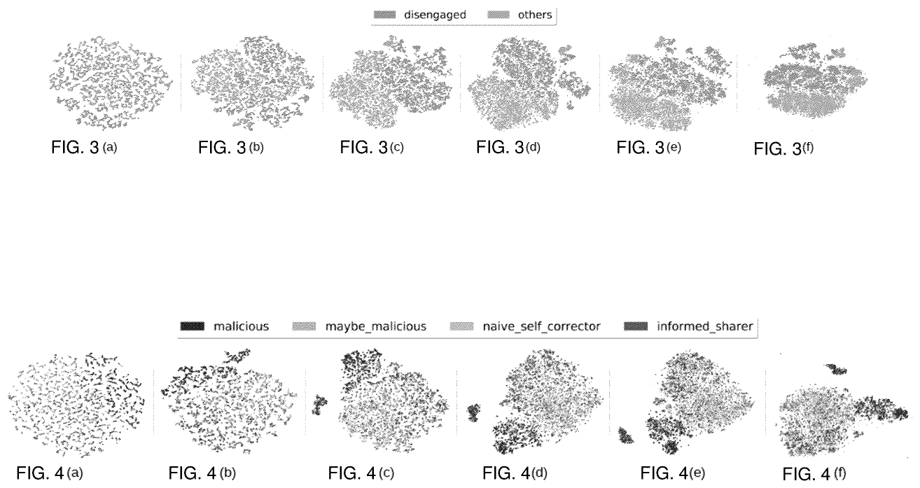

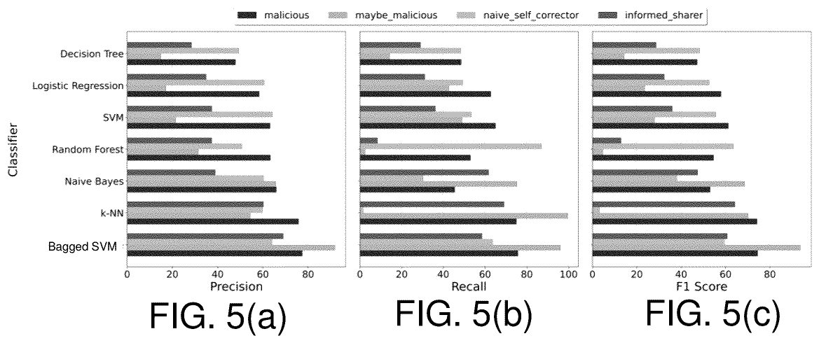

Both LINE and PBG embeddings show similar results in prediction. The LINE embedding method performed faster than PBG during our experiment. FIGS. 3a-3f show different t-distributed stochastic neighbor embedding (t-SNE) plots for different dimensional LINE embeddings where separation between the disengaged class and others class is very clear as we increase the number of dimensions. Specifically, FIGS. 3a, 3b, 3c, 3d, 3e and 3f are for 4, 8, 16, 32, 64 and 128 dimensional embeddings, respectively. For 4 and 8 dimensional LINE embeddings, (FIG. 3a and FIG. 3b), samples from both the groups are very scattered, but clusters start to appear from 16 dimensions (FIG. 3c). Similarly, FIGS. 4a-4f show the t-SNE plots for the LINE embeddings of different dimensions for the four non disengaged classes. Specifically, FIGS. 4a, 4b, 4c, 4d, 4e and 4f are for 4, 8, 16, 32, 64 and 128 dimensional embeddings, respectively. As we increase the number of dimensions of the embeddings, clusters start forming, i.e., people from the malicious class have formed a cluster on the right and top part of FIG. 4f whereas people from the informed_sharer class have formed a cluster on the bottom part of that Figure.

Table 1 shows the performance of the two-class classifiers using LINE embeddings with 128 dimensions. After using embeddings from different dimensions, we have observed that SVM and Bagged SVM have consistently performed better (precision over 95% and recall over 99%) than other classifiers when the number of dimensions is above 16. Bagged SVM achieves 95.874% precision for 128-dimensional LINE embeddings which outperforms the baseline models.

TABLE 1
Precision, recall, f1-score, and accuracy (%) of different machine
learning models for the two-class classification step using 10-
fold cross-validation. Note that while predicting all samples as
the majority class, baseline 1 produces undefined precision and
F1 score as expected, which are represented by ‘—’ in the table.

| Classifier | Precision | Recall | F1-score | Accuracy |
|---|---|---|---|---|
| Baseline 1 | — | 0 | — | 97.601 |
| Baseline 2 | 1.896 | 40.000 | 3.619 | 48.920 |
| Naïve Bayes | 9.956 | 81.000 | 17.518 | 77.527 |
| Decision Tree | 14.423 | 81.000 | 24.459 | 87.486 |
| k-NN | 36.663 | 99.000 | 52.297 | 94.069 |
| Random Forest | 76.861 | 94.000 | 83.047 | 98.870 |
| Logistic Regression | 86.115 | 99.000 | 91.320 | 99.455 |
| SVM | 95.783 | 99.000 | 97.219 | 99.858 |
| Bagged SVM | 95.874 | 100.000 | 97.743 | 99.880 |

Table 2 reports the accuracy and the weighted F1 score of the multi-class classification step using 128 dimensional LINE embeddings whereas FIGS. 5a, 5b, and 5c are graphs of their precision, recall and F1 score, respectively, using a bar plot. k-NN and bagged SVM have consistently produced better output than other classifiers where bagged SVM has performed slightly better than k-NN. For example, the precision for the malicious class using k-NN is 75.812% and using bagged SVM is 77.446%. The recall for this class is about the same (˜75%) for both classifiers. The precision for the maybe_malicious, naïve_self_corrector and informed_sharer classes are 92.078%, 64.246%, 69.073% using bagged SVM, respectively and 54.57%, 59.893%, 60.327% using k-NN, respectively. Moreover, Bagged SVM has achieved an accuracy score of 73.637% and a weighted F1 score of 72.215%. All of these numbers demonstrate the better prediction capability of these models than the baseline models shown in Table 3. After comparing the performance of the models using embeddings of different dimensions, we have observed improvement in the performance as we have increased the number of dimensions.

TABLE 2
Accuracy (%) and weighted F1 score (%) of different machine
learning models along with baseline models for the multi-
class classification step using 10-fold cross-validation.

| Classifier | Accuracy | Weighted F1 |
|---|---|---|
| Baseline 1 | 41.329 | 24.172 |
| Baseline 2 | 25.108 | 26.988 |
| k-NN | 61.412 | 53.095 |
| Logistic Regression | 48.273 | 47.451 |
| Naïve Bayes | 53.328 | 51.926 |
| Decision Tree | 41.758 | 41.247 |
| Random Forest | 53.546 | 45.285 |
| SVM | 52.239 | 50.783 |
| Bagged SVM | 73.637 | 72.215 |

TABLE 3
Precision, recall and F1 score of four different non disengaged classes using
the baseline models for the multi-class classification step. All the values
are in percentages. Note that while predicting all samples as the majority
class, baseline 1 produces undefined precision and F1 score for the non-majority
classes as expected, which are represented by ‘—’ in the table.

| | Baseline 1 | | | Baseline 2 | | |
|---|---|---|---|---|---|---|
| Class Categories | Precision | Recall | F1 Score | Precision | Recall | F1 Score |
| malicious | — | 0 | — | 25.795 | 23.397 | 24.537 |
| maybe_malicious | — | 0 | — | 23.423 | 23.423 | 10.038 |
| naïve_self_corrector | 41.329 | 100 | 58.486 | 26.229 | 26.229 | 32.418 |
| informed_sharer | — | 0 | — | 25.511 | 25.511 | 24.708 |

The experimental results show the efficacy of the various embodiments. Increasing the number of dimensions improves the performance of the model initially but this improvement slows down as we reach 64d. However, the metric which should be used for model selection and tuning depends on the mitigation techniques used to fight misinformation dissemination. For instance, if malicious people are decided to be banned, then precision should be emphasized since we do not want to ban any good account. On the other hand, if treating the followers of the malicious people with refutation is taken as a preventive measure, then recall should be the focus. If both measures are taken, then the F1 score has to be maximized. The proposed model can be applied to any social network to fight misinformation spread.

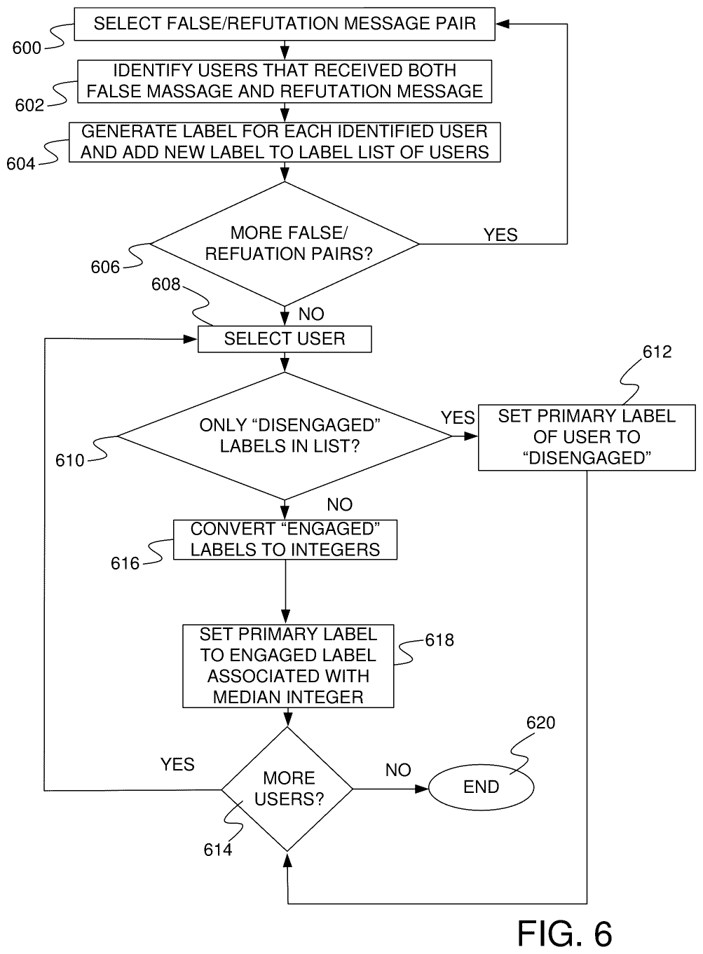

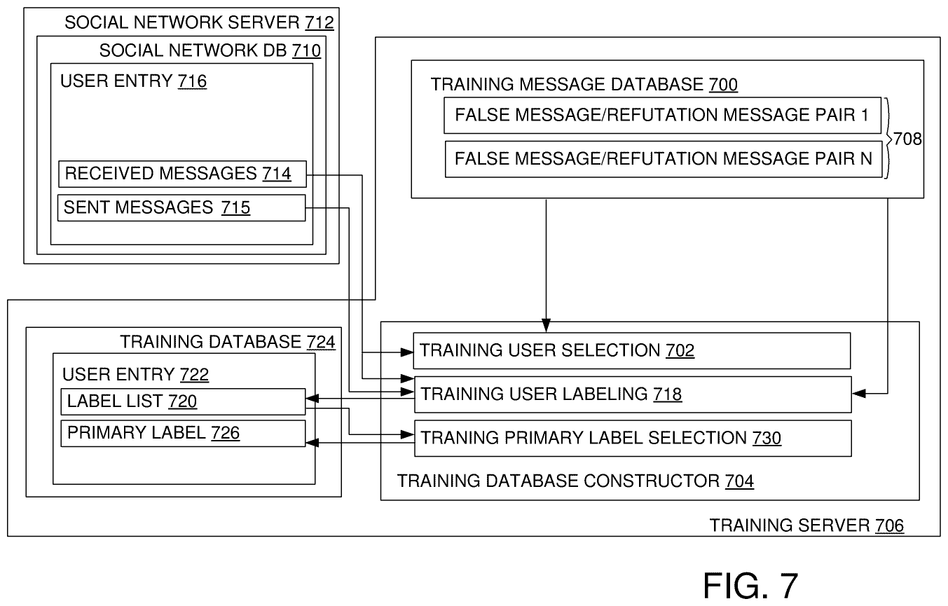

FIG. 6 provides a flow diagram of a method of labeling social network users to form training data for constructing classifiers in accordance with one embodiment. FIG. 7 provides a block diagram of elements used in the method of FIG. 6. In one embodiment, the method of FIG. 6 is performed by modules in a training database constructor 704 that executes on a training server 706.

In step 600 of FIG. 6, a user selection module 702 of training database constructor 704 selects a false message/refutation message pair from a collection of false message/refutation message pairs 708 in a training message database 700. Each false message/refutation message pair consists of a false message that contains at least one false statement and a refutation message that refutes at least one of the false statements in the false message. In accordance with one embodiment, training message database 700 is stored on training server 706. In accordance with one embodiment, each false message/refutation message pair is identified from messages sent within a social network.

At step 602, user selection module 702 searches a social network database 710 housed on a social network server 712 to identify users that received both the false message and the refutation message in the selected false message/refutation message pair. In particular, user selection module 702 performs a search of user entries 716 in social network database 710 to identify those user entries 716 that have both the false message and the refutation message within a list of received messages 714 stored for the user entry.

User selection module 702 provides the list of identified users to a training user labeling module 718, which generates a label for each identified user based on the current false message/refutation message pair at step 604. The steps for assigning this label to a user under one embodiment are described with reference to FIG. 2. In accordance with the embodiment of FIG. 2, there are five possible labels with one disengaged label and four engaged labels: malicious; maybe_malicious; naïve_self_corrector; and informed_sharer.

Before beginning the process of FIG. 2, training user labeling module 718 obtains the times when the user received the false message and the refutation message and the times at which the user sent a copy of the false message (if the user sent a copy of the false message) and the times at which the user sent a copy of the refutation message (if the user sent a copy of the refutation message). This information is obtained from received messages 714 and sent messages 715 of user entry 716.

At state A of FIG. 2, training user labeling module 718 determines whether the user received the false message or the refutation message first. If the user received the false message first, module 718 moves along edge 200 to state B where module 718 determines whether the user sent a copy of the false message before receiving the refutation message. If the user sent a copy of the false message before receiving the refutation message, module 718 moves along edge 204 to state C and then along edge 206 to state D. If the user did not send another copy of the false message after receiving the refutation message and did not send a copy of the refutation message, module 718 labels the user as maybe_malicious at state D. If the user sent a copy of the false message after receiving the refutation message, module 718 sets the label for the user to malicious at state F. If the user sent a copy of the refutation message after receiving the refutation message, module 718 sets the label for the use to naïve_self_corrector at state E.

Returning to state B, when the user received the refutation message before sharing the false message, module 718 sets the label of the user based on whether the user sent a copy of either message and the order in which the user sent those messages. If the user did not send a copy of either the false message or the refutation message, the label for the user is set to disengaged at state G. If the user sent a copy of just the false message, module 718 sets the label of the user to malicious at state I. If the user sent a copy of the false message and then a copy of the refutation message, module 718 sets the label of the user to naïve_self_corrector at state T. If the user only shared the refutation message, module 718 sets the label of the user to informed_sharer at state H. If the user sent a copy of the refutation message followed by a copy of the false message, module 718 sets the user label to maybe_malicious at state S.

Returning to state A, when the user received the refutation message first, training user labeling module 718 moves along edge 202 to state J, where module 718 determines whether the user sent a copy of the refutation message before receiving the false message. When the user sent a copy of the refutation message at state J before receiving the false message at state K, module 718 moves to state L. If the user did not send another copy of the refutation message and did not send a copy of the false message at state L, module 718 sets the label of the user to informed_sharer at state L. If the user sent another copy of the refutation message after reaching state L, module 718 sets the user label to informed_sharer at state N. If the user shared a copy of the false message after reaching state L, module 718 sets the user label to maybe_malicious at state M.

Returning to state J, if the user received a false message before sharing the refutation message, module 718 moves to state O, where it determines if the user shared either the false message of the refutation message. If the user did not send copies of either the false message or the refutation message, module 718 labels the user as disengaged at state O. If the user shared a copy of the false message but did not share a copy of the refutation message, module 718 sets the user label to malicious at state P. If the user first shared the false message and then shared the refutation message, module 718 sets the user label to naïve_self_corrector at state R. If the user shared the refutation message but did not share the false message, module 718 sets the user label to informed_sharer at state Q. If the user first shared the refutation message and then shared the false message, module 718 sets the user label to maybe_malicious at state U.

After determining the label, training user labeling module 718 adds the label to a label list 720 maintained in a user entry 722 of a training database 724 on training server 706. Label list 720 contains a separate label for each false message/refutation message pair that a user received. The process described by FIG. 2 is repeated for each user selected by user selection module 702 for the currently selected false message/refutation message pair. As such, the label list of each of the selected users is updated with a label for the current false message/refutation message pair.

Returning to FIG. 6, after a label has been provided for each user selected by user selection module 702, training database constructor 704 determines if there are more false message/refutation message pairs in training database constructor 704 at step 606. If there are more pairs, the process of FIG. 6 returns to step 600 to select the next false message/refutation message pair from training message database 700. Steps 602 and 604 are then repeated for the new message pair.

When all of the false message/refutation message pairs 708 have been processed at step 606, training database constructor 704 determines a primary label for each user identified by user selection module 702. Note that different users are selected for different false message/refutation message pairs and the full set of selected users is the union of the users selected by user selection module 702 each time step 602 is performed. Each selected user has a separate user entry 722 in training database 724.

At step 608, a primary label selection module 730 selects one of the users in training database 724 and retrieves the label list 720 of the selected user. At step 610, primary label selection module 730 determines if the retrieved label list 720 only includes the disengaged label at step 610. If the only label in label list 720 is disengaged, the primary label of the user is set to “disengage” at step 612 and is stored as primary label 726 in user entry 722.

When label list 720 of the selected user contains a label other than disengaged, such as one of the engaged labels: malicious, maybe_malicious, naïve_self_corrector, and informed_sharer, the process of FIG. 6 continues at step 616 where the engaged labels are converted into integers. In accordance with one embodiment, the following integers are assigned to the engaged labels: malicious=1, maybe_malicious=2, naïve_self_corrector=3, and informed_sharer=4.

After the engaged labels have been converted into integers at step 616, the primary label for the user is set to the median integer. For example, if the user had been labeled malicious three times and had been labeled informed_sharer once, the conversion of the label list to integers would result in [1,1,1,4], which has a median value of 1. This median value is then converted back into its corresponding label and that label is set as primary label 726 for the user at step 618.

After steps 612 and 618, the process then continues at step 614 where primary label selection module 730 determines if there are more users in training database 724. If there is another user, the process continues by returning to step 608. When all of the users have been processed at step 614, the method of FIG. 6 ends at step 620.

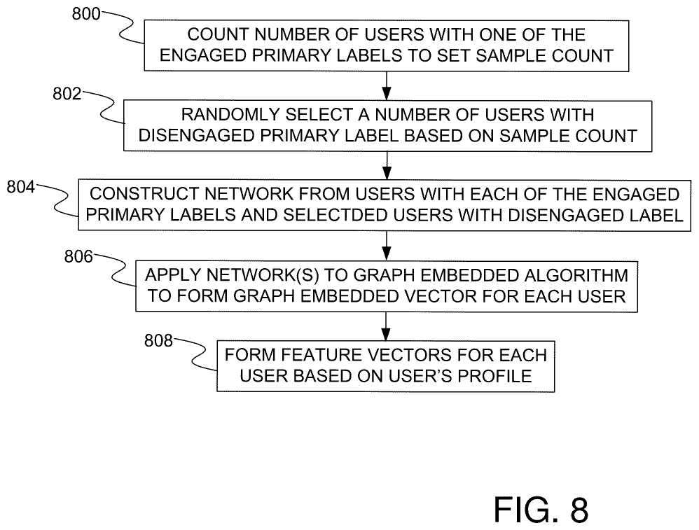

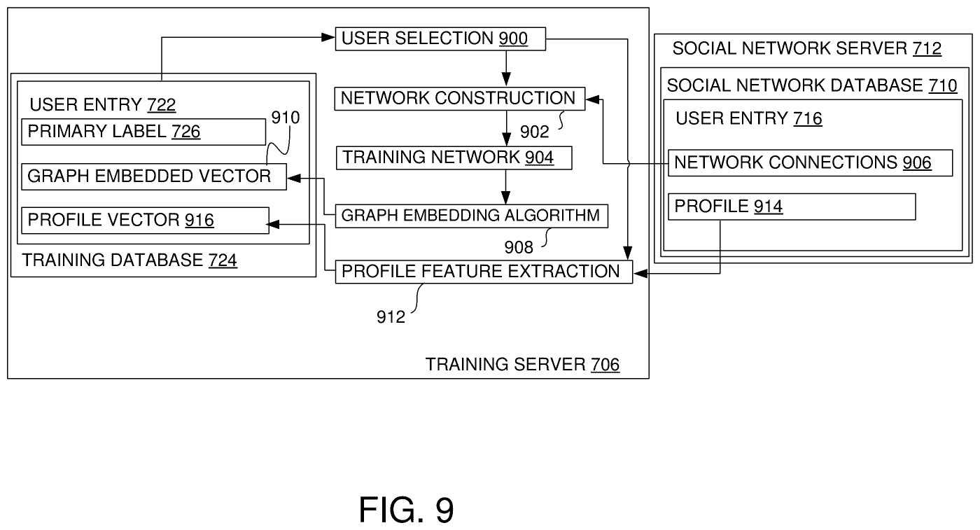

FIG. 8 provides a flow diagram of a method of generating feature vectors for training classifiers in accordance with one embodiment. FIG. 9 provides a block diagram of elements used in the method of FIG. 8.

In step 800 of FIG. 8, user selection module 900 of training server 706 counts the number of users in training database 724 that have a primary label 726 that is one of the engaged labels such as malicious, maybe_malicious, naïve_self_corrector, and informed_sharer. For example, if there are four users with malicious as their primary label 726, and twelve users with maybe_malicious as their primary label 726, user selection module 900 would return a count of sixteen engaged users at step 800. Because over 99% of the users will receive the “disengaged” primary label, there are many more disengaged users than users having one of the engaged primary labels.

At step 802, user selection module 900 randomly selects a number of users that have disengaged as their primary label 726. The number of disengaged users that are selected is based on the count of engaged users determined in step 800. In accordance with one embodiment, the number of users having the disengaged primary label is chosen to be roughly equal to the number of users that have one of the engaged primary labels. By selecting a similar number of disengaged and engaged users, the classifiers constructed from the selected users are more accurate.

At step 804, a network construction module 902 constructs a network from the selected engaged and disengaged users. This produces a training network 904. To construct the network, network construction module 902 requests the network connections 906 of each of the engaged users and the randomly selected disengaged users from social network database 710 on social network server 712. Network connections 906, in accordance with one embodiment, consists of the users followed by a user and the users that the user follows. Training network 904 may consist of a single connected network or multiple distinct networks.

At step 806, the training network(s) 904 are provided to a graph embedding algorithm 908 to form a graph embedded vector 910 for each user. Each graph embedded vector 910 is a lower dimension vector that represents first and second order connections between the user and other users. In accordance with one embodiment, each graph embedded vector 910 is stored in the respective user entry 722 of training database 724.

At step 808, a profile feature extraction unit 912 accesses a profile 914 in user entry 716 of social network database 710 to generate a profile vector 916 for each of the users with an engaged primary label and each of the randomly selected users with a disengaged primary label. In accordance with one embodiment, profile 914 includes a follower count for the user, a followee count for the user, a number of messages sent by the user, whether the user is verified or not, whether the user's account is protected or not, and the creation date for the user account. Such profile information is exemplary and additional or different profile information may be used. After step 808, a graph embedded vector 910 and a profile vector 916 have been constructed for each user with one of the engaged labels and for each of the randomly selected users with the disengaged label.

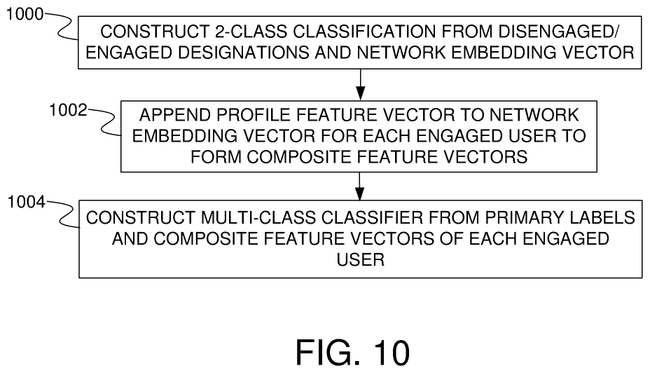

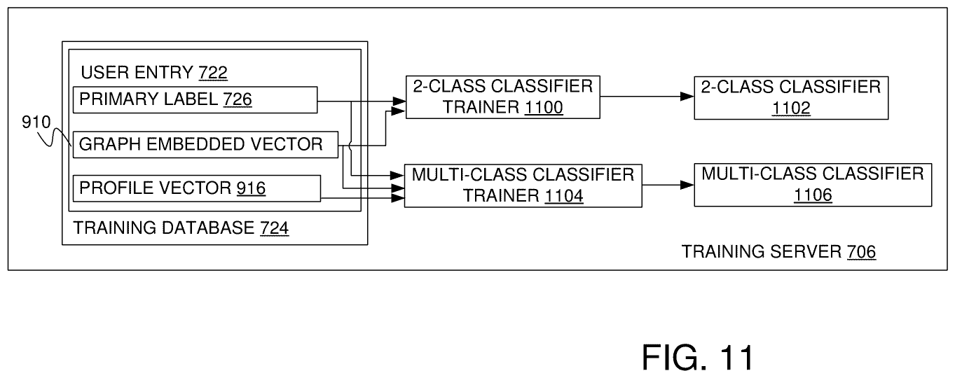

FIG. 10 provides a method of constructing classifiers in accordance with one embodiment. FIG. 11 provides a block diagram of elements used in the method of FIG. 10.

In step 1000 of FIG. 10, a two-class classifier trainer 1100 constructs a two-class classifier 1102 using the primary label 726 and the graph embedded vector 910 of users in training database 724. Before constructing the two-class classifier, trainer 1100 first assigns each user with a graph embedded vector 910 to either an engaged class or a disengaged class based on the user's primary label 726. Specifically, if the user's primary label 726 is disengaged, the user is assigned to the disengaged class. If the user's primary label 726 is one of the engaged labels such as malicious, maybe_malicious, naïve_self_corrector, and informed_sharer, the user is assigned to the engaged class. In other words, if the user's primarily label 726 is anything other than the disengaged label, the user is assigned to the engaged class. Using the disengaged/engaged designations, two-class classifier trainer 1100 uses the corresponding graph embedded vectors 910 to train two-class classifier 1102 so that two-class classifier 1102 correctly classifies users into the disengaged class and the engaged class based on graph embedded vectors. The disengaged class represents users who did not send a copy of the message containing false information and did not send a copy of the message containing the refutation of the false message. The engaged class represents users who sent at least one of a copy of the message containing false information and a copy of the message containing the refutation of the false message.

At step 1002, a multi-class classifier trainer 1104 selects user entries 722 that have an engaged primary label 726. As noted above, an engaged primary label is any primary label other than a disengaged primary label. For each user with an engaged primary label 726, multi-class classifier trainer 1104 appends the profile vector 916 to the graph embedded vector 910 of the user to form a composite feature vector. At step 1004, multi-class classifier trainer 1104 uses the composite feature vectors and the primary labels 726 to generate a multi-class classifier 1106 that is capable of classifying users into one of multiple engaged classes based on the user's composite feature vector. In accordance with one embodiment, there is a separate engaged class for each of the malicious, maybe_malicious, naïve_self_corrector, and informed_sharer primary labels. The resulting multi-class classifier 1106 is then able to classify engaged users into a class for one of the engaged primary labels based on the user's composite vector. Although four engaged classes are used in the example above, any number of engaged classes may be used in other embodiments.

In accordance with one embodiment the classes of the multi-class classifier include:
a first class representing users who sent a copy of a message containing the false information after receiving a message containing the refutation of the false information (malicious users);
a second class representing users who sent a copy of the message containing the false information before receiving the message containing the refutation of the false information and who did not send a copy of the message containing the refutation of the false information (maybe_malicious users);
a third class representing users who sent a copy of the message containing the false information and then sent a copy of the message containing the refutation of the false information (naïve_self_corrector user); and
a fourth class representing users who sent a copy of the message containing the refutation of the false information but who did not send a copy of the message containing the false information (informed_sharer user).

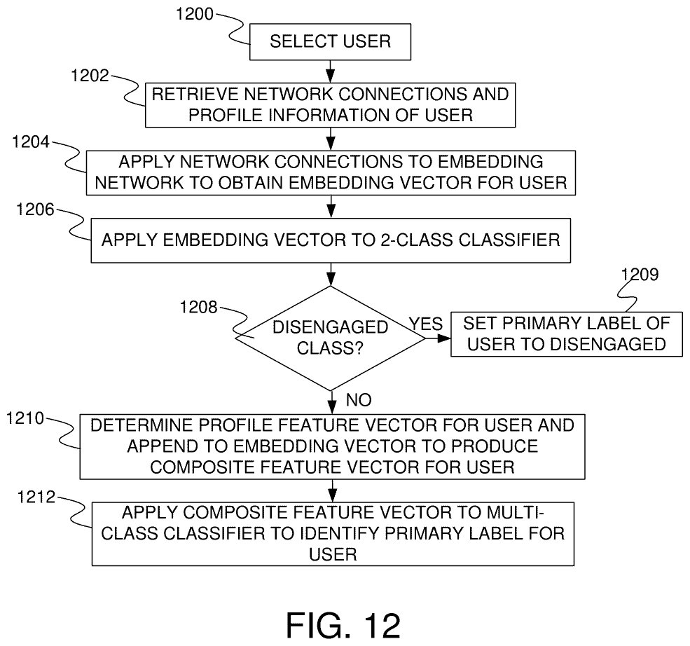

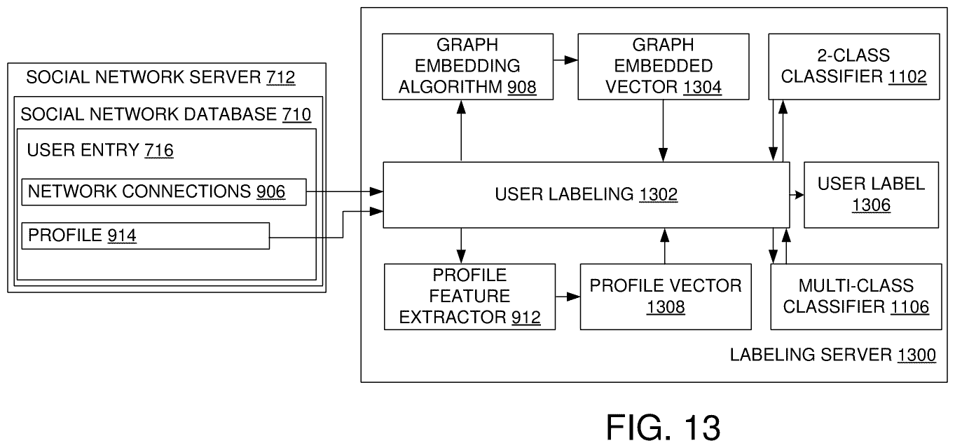

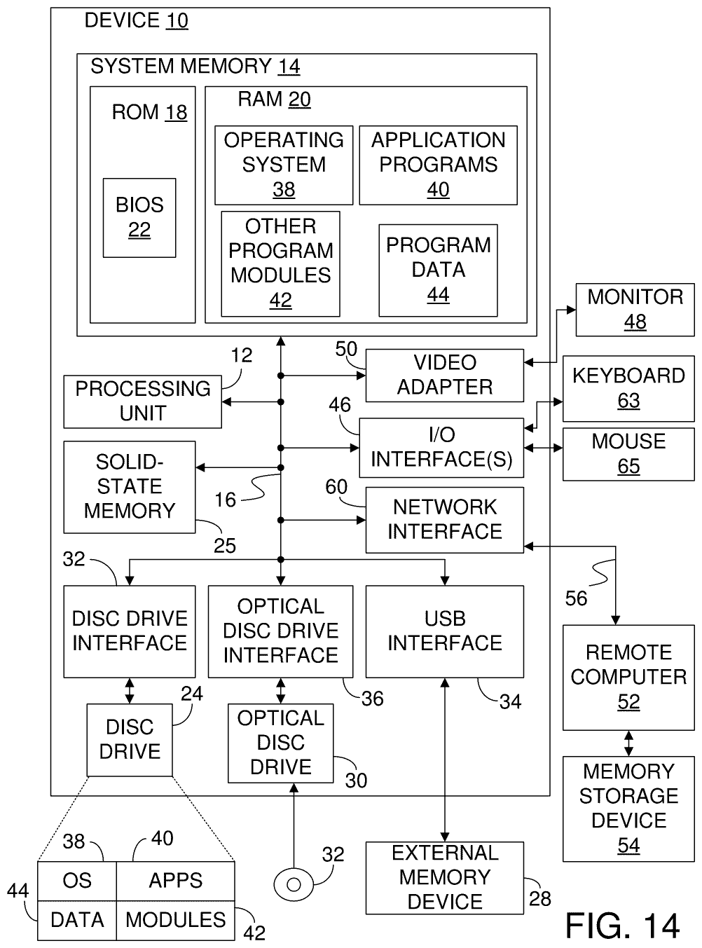

FIG. 12 provides a flow diagram for assigning a primary label to a user without using the message history of the user. FIG. 13 provides a block diagram of elements used in the method of FIG. 12.

In step 1200, a user labeling component 1302 executing on a labeling server 1300 selects a user from a social network database 710 executing on a social network server 712. At step 1202, user labeling component 1302 retrieves the network connections and profiles information for the user. At step 1204, user labeling component 1302 applies the network connections of the user to graph embedding algorithm 908 to produce a graph embedded vector 1304 for the user. At step 1206, user labeling component 1302 applies the graph embedded vector 1304 to the two-class classifier 1102, which uses the graph embedded vector 1304 to assign the user to either the disengaged class or the engaged class. If two-class classifier 1102 assigns the user to the disengaged class at step 1208, the primary label 1306 of the user is set to disengage. at step 1209.

When the user is not assigned to the disengaged class at step 1208, user labeling component 1302 retrieves the profile 914 for the user from social network database 710 and applies the profile-to-profile feature extraction unit 912 to produce a profile vector 1308 for the user at step 1210. Note that the profile vector is only produced for a user if the user is not disengaged. Since most users are disengaged, classifying the user as engaged before producing a profile vector for the user significantly reduces the workload on labeling server 1300.

After generating profile vector 1308, user labeling component 1302 appends profile vector 1308 to graph embedded vector 1304 of the user to form a composite feature vector for the user. At step 1212, user labeling component 1302 applies the composite feature vector to multi-class classifier 1106, which assigns the user to one of the multiple engaged classes at step 1212. For example, in the embodiment of FIG. 2, multi-class classifier 1106 assigns the user to one of the classes associated with the malicious, maybe_malicious, naïve_self_corrector, and informed_sharer primary labels. User labeling 1302 then assigns the user the primary label associated with the class identified by multi-class classifier 1106.

Note that in identifying the label for the user, the system of FIG. 13 does not require the message history of the user. In other words, the system does not need to know what messages the user has received in the past or what messages the user has resent in the past in order to determine how the user will react to false messages and refutations of false messages. This greatly reduces the amount of work needed to be performed by the computing system in order to label a particular user. In addition, for users with a limited message history, the system is able to predict the user's reaction to false messages and refutations of messages before the user has even received a false message.

FIG. 14 provides an example of a computing device 10 that can be used to as any of the servers described above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes an optional hard disc drive 24, an optional external memory device 28, and an optional optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of modules discussed above. Program data 44 may include any data used by the systems and methods discussed above.

Processing unit 12, also referred to as a processor, executes programs in system memory 14 and solid state memory 25 to perform the methods described above.

Input devices including a keyboard 63 and a mouse 65 are optionally connected to system bus 16 through an Input/Output interface 46 that is coupled to system bus 16. The monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 14. The network connections depicted in FIG. 14 include a local area network (LAN) or wide area network (WAN) 56. Such network environments are commonplace in the art. The computing device 10 is connected to the network through a network interface 60.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 14 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method comprising:
setting a respective label for a plurality of users, wherein the plurality of users is limited to users who have received both a message containing false information and a message containing a refutation of the false information;
constructing a classifier using the labels of the users; and
using the classifier to determine a label for an additional user.

2. The method of claim 1 wherein constructing the classifier comprises constructing a two-class classifier comprising:
a first class representing users who did not send a copy of the message containing false information and did not send a copy of the message containing the refutation of the false message; and
a second class representing users who sent at least one of a copy of the message containing false information and a copy of the message containing the refutation of the false message.

3. The method of claim 1 wherein constructing the classifier comprises constructing a multi-class classifier comprising:
a first class representing users who sent a copy of the message containing the false information after receiving the message containing the refutation of the false information.

4. The method of claim 3 wherein the multi-class classifier further comprises:
a second class representing users who sent a copy of the message containing the false information before receiving the message containing the refutation of the false information and who did not send a copy of the message containing the refutation of the false information.

5. The method of claim 4 wherein the multi-class classifier further comprises:
a third class representing users who sent a copy of the message containing the false information and then sent a copy of the message containing the refutation of the false information.

6. The method of claim 5 wherein the multi-class classifier further comprises:
a fourth class representing users who sent a copy of the message containing the refutation of the false information but who did not send a copy of the message containing the false information.

7. The method of claim 6 wherein constructing a classifier further comprises constructing a two-class classifier in addition to the multi-class classifier and wherein using the classifier to determine a label for the additional user comprises using at least one of the two-class classifier and the multi-class classifier.

8. The method of claim 7 wherein the two-class classifier comprises:
a first class representing users who did not send a copy of the message containing false information and did not send a copy of the message containing the refutation of the false message;
a second class representing users who sent at least one of a copy of the message containing false information and a copy of the message containing the refutation of the false message.

9. The method of claim 8 wherein using at least one of the two-class classifier and the multi-class classifier comprises:
using the two-class classifier to determine whether the additional user is in the first class of the two-class classifier or the second class of the two-class classifier; and
only when the user is in the second class of the two-class classier, using the multi-class classifier to determine which of the first, second, third and fourth class of the multi-class classifier the additional user is in and determining the label for the additional user based on which of the first, second, third and fourth class of the multi-class classifier the additional user is in.

10. The method of claim 9 further comprising:
determining a connection network for the additional user; and
applying the connection network to a graph embedding algorithm to obtain an embedding vector.

11. The method of claim 10 wherein using the two-class classifier comprises applying the embedding vector to the two-class classifier.

12. The method of claim 10 further comprises determining a feature vector from a profile of the additional user and wherein using the multi-class classifier comprises applying the embedding vector and the feature vector to the multi-class classifier.

13. A method comprising:
retrieving social network connections of a user from a database;
using the social network connections to assign a label to the user, the label indicating how the user will react to messages containing misinformation and messages containing refutations of misinformation, the label being assigned to the user without determining how the user has reacted to past messages containing misinformation.

14. The method of claim 13 wherein using the social network connections to assign the label to the user comprises:
applying the social network connections to a graph embedding algorithm to produce a graph embedded vector; and
applying the graph embedded vector to at least one classifier.

15. The method of claim 14 wherein applying the graph embedded vector to at least one classifier comprises:
applying the graph embedded vector to a two-class classifier to determine whether to assign a disengaged label to the user that indicates that the user is expected to not send copies of messages containing misinformation and is not expected to send copies of messages containing refutations of misinformation.

16. The method of claim 15 wherein applying the graph embedded vector to at least one classifier further comprises:
when the user is not assigned the disengaged label, applying the graph embedded vector to a multi-class classifier to assign one of a plurality of labels to the user.

17. The method of claim 16 wherein the plurality of labels comprise:
a malicious label indicating that the user is expected to send a copy of a message containing misinformation after receiving a message containing a refutation of the misinformation;
a maybe-malicious label indicating that the user is expected to send a copy of a message containing misinformation before receiving a message containing a refutation of the misinformation and are further expected to not send a copy of the message containing the refutation;
a naïve label indicating that the user is expected to send a copy of a message containing misinformation before receiving a message containing a refutation of the misinformation and is further expected to send a copy of the message containing the refutation of the misinformation; and
an informed-sharer label that indicates that the user is expected to not send a copy of a message containing misinformation.

18. A system comprising:
a two-class classifier that places a user in one of two classes based upon social network connections of the user; and
a multi-class classifier that places the user in one of a plurality of classes based upon the social network connections of the user, wherein the multi-class classifier is not used when the user is placed in a first class of the two classes by the two-class classifier and is used when the user is placed in a second class of the two classes by the two-class classifier.

19. The system of claim 18 wherein the two-class classifier and the multi-class classifier place the user in a class without information about how the user has interacted with messages in the past.

20. The system of claim 18 further comprising a graph embedding algorithm wherein the social network connections of the user are applied to the graph embedding algorithm to produce a graph embedded vector and the two-class classifier and the multi-class classifier classify the user based on the graph embedded vector.
